(19) United States
(12) Patent Application Publication
(10) Pub. No.: US 2008/0209525 A1
(43) Pub. Date: Aug. 28, 2008

(54) APPLICATIONS AND USES FOR SYSTEM AND METHOD OF CONTROLLING AND MONITORING COMPUTER PROGRAM USAGE

(76) Inventor: Yaron BEN-SHOSHAN, Nahariya (IL)

Correspondence Address: Pearl Cohen Zedek Latzer, LLP, 1500 Broadway, 12th Floor, New York, NY, 10036, US

(21) Appl. No.: 12/034,803

(22) Filed: Feb. 21, 2008

Related U.S. Application Data
(63) Continuation-in-part of application No. 11/318,448, filed on Dec. 28, 2005.
(60) Provisional application No. 60/680,230, filed on May 13, 2005.
(60) Provisional application No. 60/902,356, filed on Feb. 21, 2007.

(51) Int. Cl. H04L 9/32

(52) U.S. Cl. 726/4

(57) ABSTRACT

Embodiments of the present invention include applications for a method of modifying a computer program to control and monitor usage, e.g., for software protection, by dividing the computer program code into protected and unprotected parts. The policy may dictate the conditions under which the resource may be released. The policy may be associated, for example, with a particular copy of the computer program being executed, or it may be associated with a user identification (for example, as identified by a user name and password), or a time limitation, or a mode of use of the software, or other conditions placed on the set of parameters received from the user machine. The policy may be dictated statically, or it may be changed dynamically by a supervisor.

### CROSS-REFERENCE TO RELATED APPLICATIONS

This application (a) is a continuation-in-part application of U.S. patent application Ser. No. 11/318,448, filed Dec. 28, 2005 and entitled “System and Method of Controlling and Monitoring Computer Program Usage”, which in turn claims priority from U.S. Provisional Application No. 60/680,230, filed May 13, 2005, and (b) claims priority from U.S. Provisional Application No. 60/902,356, filed Feb. 21, 2007, and entitled “Applications and Uses for System and Method of Controlling and Monitoring Computer Program Usage” the entire disclosures of all of which applications are incorporated herein by reference herein.

### FIELD OF THE INVENTION

The invention relates to the field of software protection and, more particularly, to methods of modifying computer program code to enable controlling and monitoring the usage of a computer program, e.g., for protection against unauthorized use.

### BACKGROUND OF THE INVENTION

Methods for controlling and/or monitoring the usage of a computer program have many applications in the marketplace. For example, protecting a computer program against unauthorized “pirate” copies (known as software protection), limiting computer program use to a predefined period of time (e.g., for a trial version), collecting statistics regarding users' usage behavior (e.g., on behalf of feedback), and counting the usage time (e.g., in conjunction with a pay-per-use billing system) may all be desirable applications.

Some existing methods for controlling and monitoring computer program usage are based on adding code to the computer program. For example, a software protection application may add an internal authorization check mechanism to an unprotected version of a computer program to check whether or not a user is authorized to execute the computer program, and halt the execution of the protected program if a user is found to be unauthorized. Such authorization checks may be implemented in several ways, including, for example, checking for the presence of a dongle or plug connected to a port of the computer; checking for the presence of a special mark on the software media, e.g., disk, CD, DVD, or the like; checking for a unique hardware ID, e.g., CPUID, MAC address or the like; checking for a specific value in a registry key in the registry file of the operating system, e.g., in Microsoft Windows operating systems; and other such checks. However, since the computer program is fully functional and capable of running properly without the added code, e.g. the authorization check mechanism , such controlling and monitoring methods may be simply bypassed, for example, by skipping over the added code.

A different approach to controlling software usage in was suggested in 1987 and implemented as a system named ABYSS (“A Basic Yorktown Security System”). The ABYSS approach for controlling software usage includes dividing a computer program into a protected part and an unprotected part. The unprotected part may be executed on the user hardware and may therefore be publicly available, whereas the protected part may be executed on a secure computing environment (“protected processor”) and is not publicly revealed in plain text form. Conditions under which the computer program can be executed may be embodied in a “right-to-execute” logical object enforced by the protected processor. The security of the protected processor, including, for example, encryption of the protected part and/or the right-to-execute logical object, may ensure that the protected part of the computer program and/or the right-to-execute object are not examined or modified by any party external to the protected processor.

The division may be chosen such that the protected part of the computer program may be difficult to reconstruct from the unprotected part of the program, i.e., it may be difficult to reverse-engineer. In addition, the partition may be designed so that both parts of the computer program may need to be present in order to execute the computer program, and eliminating access between the protected part and the unprotected part of the program may result in a nonfunctional computer program. For these reasons, the ABYSS protection approach may be more immune to attacks than the aforementioned authorization check mechanism. However, the ABYSS authors did not disclose a particular method of dividing a computer program for implementation of their security system.

Some existing code division methods may work well for non-realtime or non-user interactive computer programs that run in the background of the user's system. However, due to network latency, they may not be suitable for realtime applications, such as user-interactive computer programs, where the protected processor and the user hardware may communicate over an Internet or other network connection. When applied to a realtime software application such as a computer game, current code division methods may cause a delay in execution of up to several seconds each time code from the protected part is called. For example, several seconds may pass from the time a user hits the fire button until a shot is fired from a weapon in the game, creating a noticeable and unacceptable delay in the user's game play experience. Typically, a delay of even 50 ms, e.g., corresponding to the frame rate of many video games, will be noticeable.

### SUMMARY OF THE INVENTION

Embodiments of the present invention include applications for a method of modifying a computer program to control and monitor usage, e.g., for software protection, by dividing the computer program code into protected and unprotected parts. According to some demonstrative embodiments of the invention, the method may receive at least one set of parameters relating to an execution of a computer program being executed on a user machine, the computer program being deficient of a mechanism to release a resource, determine based on said set of parameters and a policy whether said resource on said user machine is to be released, and if the resource is to be released, send a result of performing said set of operations to said user machine to instruct the release of said resource on said user machine.

The policy may be as described in any of the below embodiments. The policy may dictate the conditions under which the resource may be released. The policy may be associated, for example, with a particular copy of the computer program being executed, or it may be associated with a user identification (for example, as identified by a user name and password), or a time limitation, or a mode of use of the software, or other conditions placed on the set of parameters received from the user machine. The policy may be dictated statically, or it may be changed dynamically by a supervisor.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanied drawings in which:

FIG. 1 is a schematic illustration of a process for modifying a computer program according to some demonstrative embodiments of the invention;

FIG. 2 is a schematic illustration of part of an execution of a computer program to be modified according to some demonstrative embodiments of the invention;

FIG. 3 is a schematic illustration of a profiling output file according to some demonstrative embodiments of the invention;

FIG. 4A is a schematic illustration of a tree data structure with complete profiling data inserted according to one demonstrative embodiment of the invention;

FIG. 4B is a schematic illustration of a tree data structure with partial profiling data inserted according to one demonstrative embodiment of the invention;

FIG. 4C is a schematic illustration of a tree data structure with splitting of a node according to one demonstrative embodiment of the invention;

FIG. 4D is a schematic illustration of a tree data structure with further partial profiling data inserted after splitting of a node according to one demonstrative embodiment of the invention;

FIG. 5 is a schematic flow chart of an algorithm to select execution paths according to some demonstrative embodiments of the invention;

FIG. 6 is a schematic illustration of a system to execute protected and unprotected parts of a modified computer program according to some demonstrative embodiments of the invention; and

FIG. 7 is a schematic illustration of part of an execution of an unprotected part of a computer program modified according to some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF THE INVENTION

In the following detailed description, numerous specific details are set forth in order to provide a thorough understanding of the invention. For example, in accordance with some non-limiting demonstrative embodiments of the invention, an ANSI C compatible programming language, IA-32 (Intel Architecture for 32-bit processors) Intel Pentium 4 hardware architecture, Microsoft Windows XP Professional operating systems, and memory heap resource are assumed for clarity of demonstration. However, it will be understood by those of ordinary skill in the art that the present invention may be practiced without these specific details and that generalization for different programming languages, hardware architectures, operating systems, and resources is possible. In other instances, well-known methods, procedures, components, and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers, or other such information storage, transmission, or display devices. In addition, the term “plurality” may be used throughout the specification to describe two or more components, devices, elements, parameters, or the like.

It should be appreciated that according to some embodiments of the present invention, the method described below may be implemented in machine-executable instructions. These instructions may be used to cause a general-purpose or special-purpose processor that is programmed with the instructions to perform the operations described. Alternatively, the operations may be performed by specific hardware that may contain hardwired logic for performing the operations, or by any combination of programmed computer components and custom hardware components.

It will be appreciated by those of ordinary skill in the art that the term “code block” as used herein refers to as a set of machine-executable instructions that appear sequentially in a computer program's code. The term “branch” or “branch instruction” as used herein refers to an instruction or statement in a code block that may direct the processor to execute an instruction other than the next sequential instruction of the code block. The term “entry point” as used herein refers to a location within the program code to which a branch directs execution.

The term “basic code block” or “basic block” as used herein refers to a code block in which the first instruction either directly follows a branch or is an entry point, the last instruction is either a branch instruction or directly precedes an entry point, and internal instructions do not include branches or entry points. Thus, a basic block may be a sequence of machine-executable instructions within a computer program's code that are executed sequentially.

The term “conditional branch” as used herein refers to a branch instruction that contains a conditional statement that may be checked upon execution of the branch and may determine whether the branch is “taken”, as it is termed in the art, or whether execution continues sequentially. The term “execution path” as used herein refers to the sequence of instructions or statements within the computer program code executed at runtime, and may depend on the branches taken.

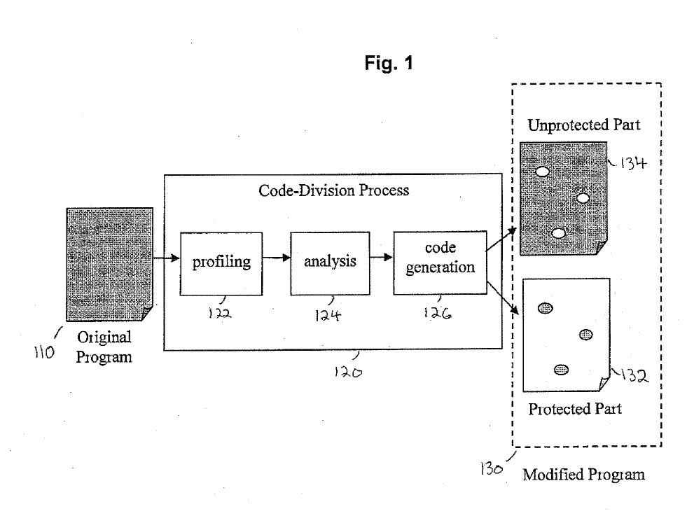

Reference is made to FIG. 1, which schematically illustrates modifying of a computer program according to some demonstrative embodiments of the invention. An original computer program 110 may be modified according to a process 120 to produce a divided computer program 130 having a protected part 132 and an unprotected part 134. Although the invention is not limited in this respect, original program 110 may be, for example, an executable file in binary code form. Alternatively, code-division process 120 may be implemented for other formats of computer program 110, e.g., the source code. Unprotected part 134 may be deficient of a mechanism to release a previously-allocated resource. Protected part 132 may include computations and/or logical expressions that may influence a resource-releasing instructions required by the unprotected part. For example, the computations included in protected part 132 may influence a resource-releasing instruction by changing the address of the resource to be released. For example, the free( ) system call, which releases dynamically allocated memory from the heap resource, requires a memory address as an input parameter. Although the invention is not limited in this respect, resource-releasing instructions may release memory, file handles, network sockets, and/or processor time, e.g., by stopping the calculation of unnecessary computations.

In accordance with some demonstrative embodiments of the invention, protected part 132 may be executed on a protected processor such as, for example, a secure remote server or an encrypted co-processor on the user's computer. Optionally, the protected part may be stored in encrypted form on the user's machine, and may be sent to the protected processor for decryption and execution. Unprotected part 134 may be executed on the user's hardware, e.g., a client machine, and may be distributed freely. Code division process 120 may include a profiling step 122, an analysis step 124, and a code generation step 126. These steps are described in detail below with reference to the remaining figures.

In accordance with some non-limiting demonstrative embodiments of the invention, profiling step 122 may include runtime profiling of original program 110, e.g., a program written in an ANSI C compatible programming language and compiled as a binary executable for Intel Pentium 4 hardware architecture and Microsoft Windows XP operating systems. Profiling step 122 may be implemented to gather data regarding, e.g., dynamically allocated memory, the free( ) system call, and related computations. For example, for each free( ) system call that is performed during execution of original program 110, the profiler may log a trace of the instructions that precede the free( ) system call, the timestamp at which the call takes place, the ID of the thread that performs the call, and the amount of memory that is freed. The preceding is assumed for demonstrative purposes only. In accordance with other demonstrative embodiments of the invention, different programming languages, hardware architectures, operating systems, and resources are possible, as is known in the art.

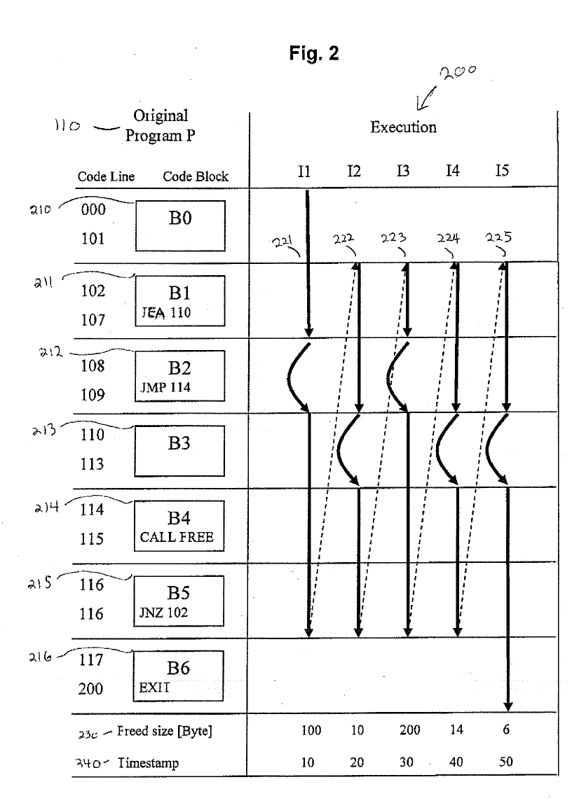

Reference is made to FIG. 2, which schematically illustrates part of an execution 200 of original computer program 110 to be profiled for code division according to some demonstrative embodiments of the invention. For example, original program 110 may include code blocks 210-216, denoted B0-B6, respectively. Initial code block B0 (210) may include one or more resource-allocation instructions, such as, e.g., the malloc( ) system call, which may dynamically allocate a desired amount of memory for use. Some of the code blocks 210-216 may include functions and conditional statements, e.g., conditional branch instructions, which may determine an execution path of the program according to the results of the functions/statements at runtime, such that the execution path may not be fixed. For example, basic block B1 (211) may end in a conditional branch instruction that directs execution to an entry point at basic block B3 (213), skipping over basic block B2 (212) when the branch is taken. Computer program 110 may contain an inner loop, e.g., block B5 (215) may direct execution back to block B1 (211), and different iterations may follow different execution paths as a result of different taken branches. In addition, some of the code blocks 210-216, e.g., block B4 (214) may include resource-releasing statements such as, e.g., the free( ) system call.

Although the invention is not limited in this respect, for clarity of demonstration, the following example may represent a portion of the source code and corresponding compiled code of original program 110:

### Source Code 1:

for(i=5; i>0; i−−){

a=A[i];
b=B[i];
c=C[i];
if(c < 2*a*b)

r = 2*a*b−c;

else

r=c\hat{ }2−4*a*b;

free(r);

}

### Compiled Code 1:

| | | |
|---|---|---|
| 101 | MOV | ECX,5 |
| 102 | MOV | EAX,2 |
| 103 | MUL | EAX,[ECX]1000 |
| 104 | MUL | EAX,[ECX]2000 |
| 105 | MOV | EBX,[ECX]3000 |
| 106 | CMP | EAX,EBX |
| 107 | JEA | 110 |
| 108 | SUB | EAX,EBX |
| 109 | JMP | 114 |
| 110 | MUL | EBX,EBX |
| 111 | MUL | EAX,2 |
| 112 | SUB | EBX,EAX |
| 113 | MOV | EAX,EBX |
| 114 | PUSH | EAX |
| 115 | CALL | free |
| 116 | LOOP | 102 |
| 117 | CALL | exit |

For example, execution 200 may include five iterations 221-225, denoted I1-I5, of a loop in program 110. As illustrated for the example, iterations I1 (221) and I3 (223) may take a branch that skips block B2 (212) during execution, while iterations I2 (222), I4 (224), I5 (225) may take a branch that skips block B3 (213) during execution, resulting in the different execution paths 221-225. In addition to taking different branches, execution paths 221-225 may release different amounts of resources, e.g., memory, as indicated at diagram line 230, and may call the associated resource-releasing command, e.g., free( ), at different times, as indicated by the call timestamp at diagram line 240. The information contained in diagram lines 230 and 240, as well as the branches taken in execution paths 211-215, may be obtained during the profiling of program 110, e.g., during profiling step 122 of code-division process 120 in FIG. 1, and stored in an output file for analysis, as explained in detail below.

As known in the art, profiling may include the use of specialized software or techniques to gather desired data about a program's execution at runtime, e.g., how long certain parts of the program take to execute, how often they are executed, which functions call which other functions, etc., for use in optimization or debugging. For example, profiling may be achieved by instrumentation, as known in the art, or by executing the program in a debug mode. In accordance with some non-limiting embodiments of the invention, profiling step 122 may include instrumentation of, e.g., the code of resource-releasing system calls, e.g., the free( ) system call that are used by the program being profiled. It will be appreciated by those skilled in the art that ready-to-use instrumentation tools such as, for example, ATOM of Digital Equipment Corporation Inc, Anvil of BitRaker Inc., and the like, are available and may provide appropriate functions for dumping profiling data.

According to some non-limiting demonstrative embodiments of the invention, profiling may include logging a trace of the several instructions that immediately precede, e.g., each free( ) system call performed during execution. Thus, the profiling data may include branch addresses for branches taken in execution, including the source address, i.e., the address of the branch instruction from which the branch splits, and the destination address, i.e., the entry point to which the branch leads. Although the invention is not limited in this respect, it may be sufficient for profiling purposes to dump content relating to, e.g., the previous ten branches executed, for analysis. This factor may depend upon various criteria, such as, for example, the degree of desired protection, the expected relevance of the instructions, and the desired length of the profiling process.

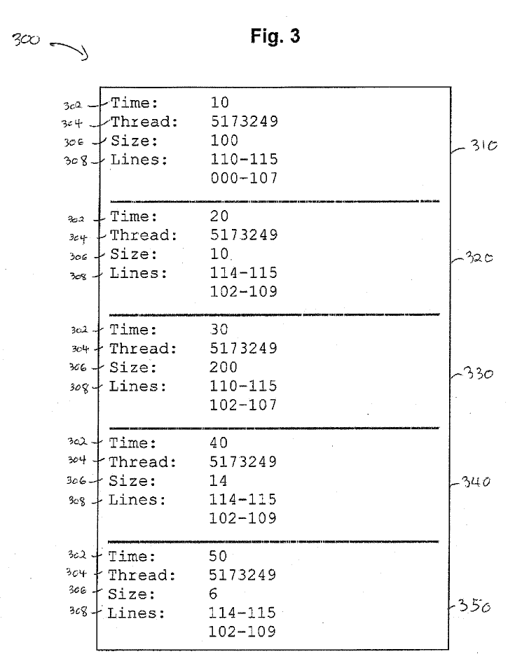

Although the invention is not limited in this respect, branch addresses of taken branches may be logged by setting the branch trace store (BTS) mechanism of Pentium 4 and Intel Xenon processors. It will be appreciated by those skilled in the art that setting a BTS flag, e.g., the 2^{nd} bit of the IA32_DEBUGCTL register, and a trace messages enable (TR) flag, e.g., the 6^{th} bit of the IA32_DEBUGCTL register, causes the CPU to log, for each branch that was taken, branch message structures (BMS) to a memory location known as the BTS buffer. In accordance with some non-limiting demonstrative embodiments of the invention, the free( ) system call may be instrumented to dump the addresses of taken branches which precede the free( ) system call from the BTS buffer to a profiling output file, such as, e.g., the profiling output file of FIG. 3 described below.

It will be appreciated that the debug trace interrupt (BTINT) flag, i.e., the 5^{th} bit of the IA32_DEBUGCTL register may be clear in order to configure the BTS buffer to work in a cyclic mode. The BTS buffer is located within the debug store (DS) save area in Pentium 4 hardware architecture, and may have associated parameters including BTS index and BTS buffer base, as known in the art. For example, the BTS buffer base indicates the first memory address of the BTS buffer, and is stored within the first double word of the buffer management area of the DS save area. The BTS index points to the BTS buffer entry where the most recent BMS was inserted, and is stored within the second double word of the buffer management area of the DS save area. The branch addresses may be stored in the BTS buffer as offsets into a code segment, in which case the corresponding segment's base address may be determined, for example, by reading the segment selector for the code segment from the stack, using the segment selector to locate the segment descriptor for the segment in the global descriptor table (GDT) or local descriptor table (LDT), and reading the segment base address from the segment descriptor.

In accordance with some demonstrative embodiments of the invention, a resource-releasing system call, e.g. the free( ) system call, may be instrumented to log the timestamp at which the resource releasing system call is executed, the thread ID of the thread that calls the resource-releasing system call and the amount of resources released by the resource-releasing system call. The timestamp counter (TSC) value may be retrieved, for example, by using the RDTSC instruction. The tread ID may be obtained, for example, by using the GetThreadID system call of the Kernel32.dll. Data regarding amount of resources released may be obtained, for example, from a computation internal to the corresponding system call.

In accordance with embodiments of the invention, a profiling output file may be created at the time the profiled program is executed in order to receive the data collected during profiling. The details regarding the creation/opening of a log file and the retrieving of its handle are well-known in the art.

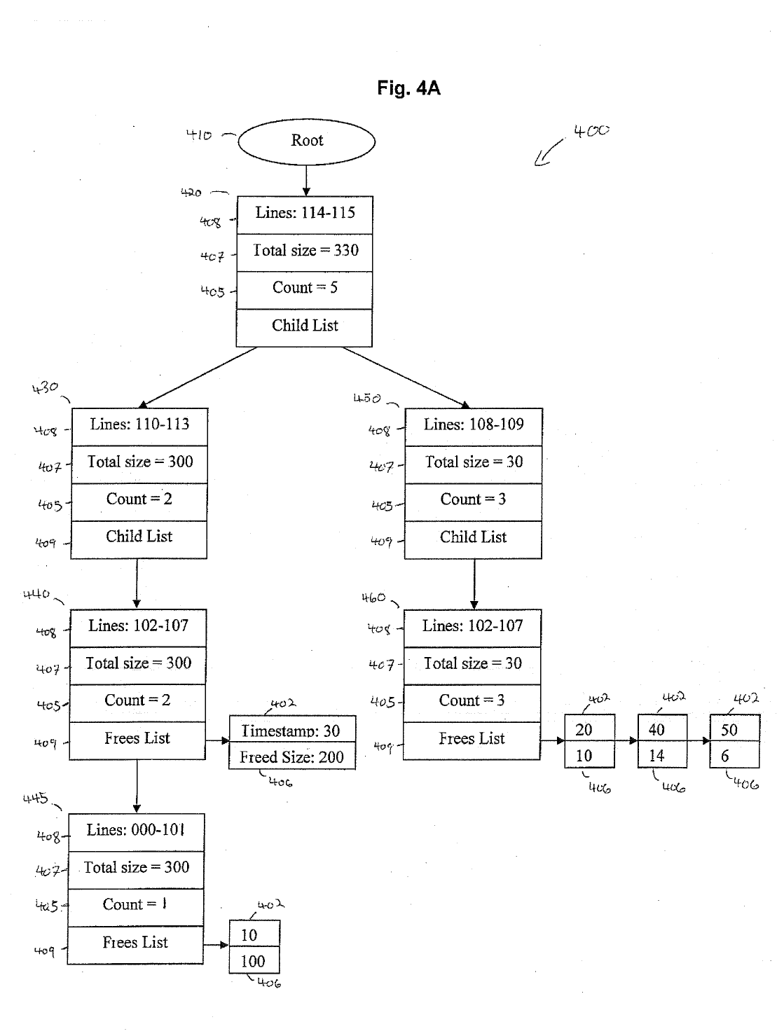

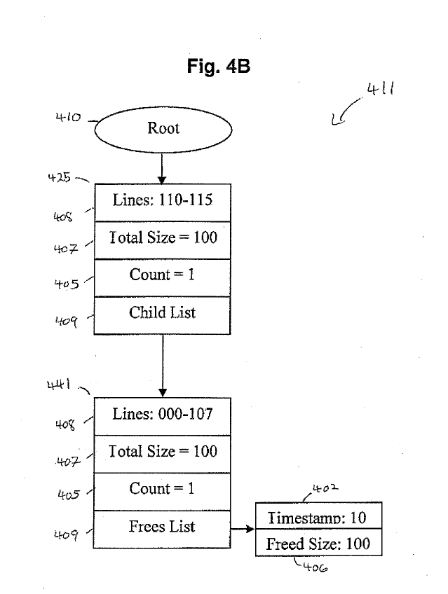

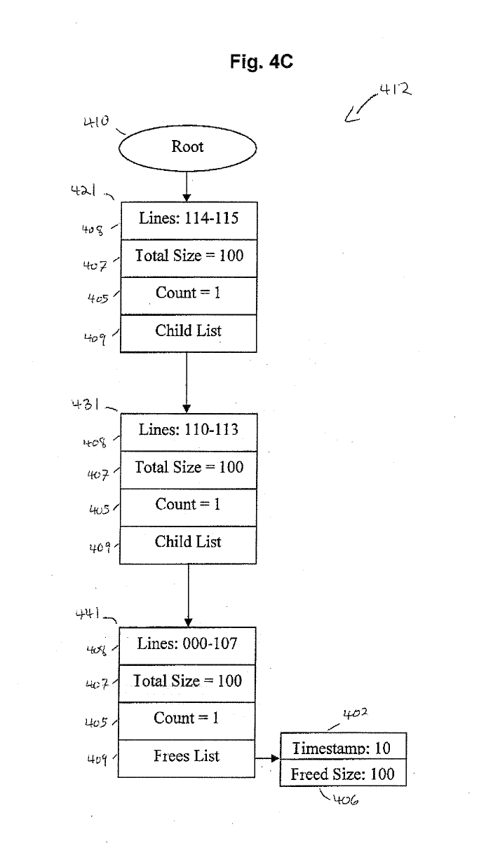

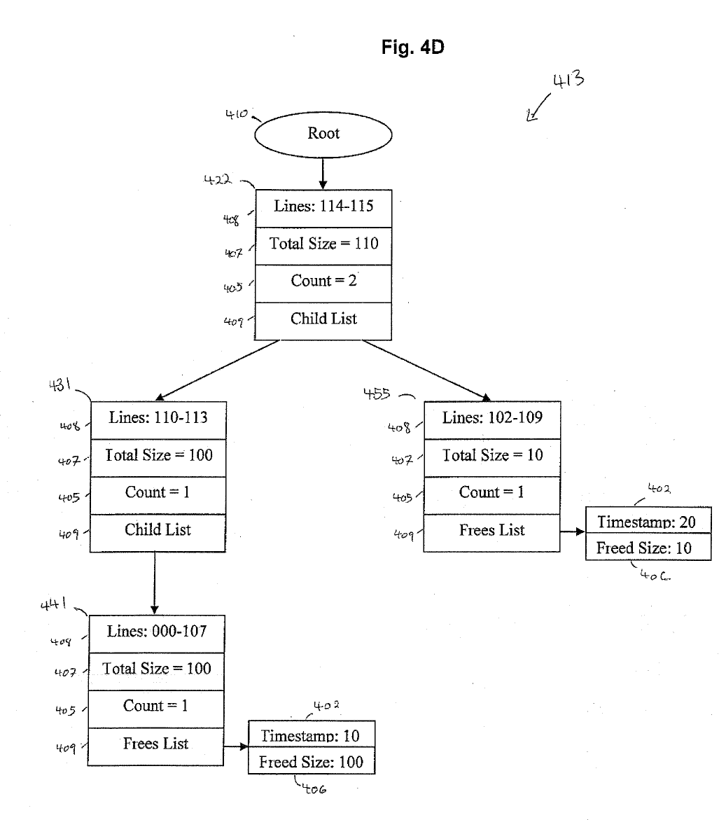

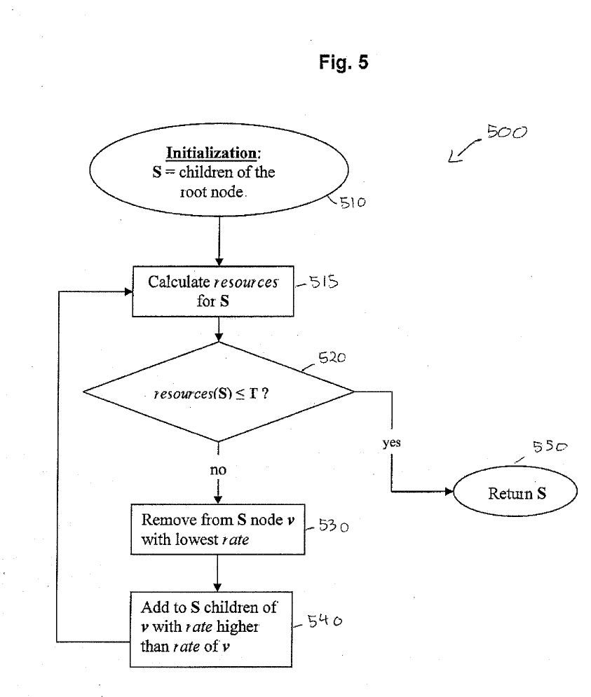

Reference is made to FIG. 3, which schematically illustrates a profiling output file 300 according to some demonstrative embodiments of the invention. Although the invention is not limited in this respect, output file 300 may include records for each call of the resource-releasing instruction profiled, e.g., records 310, 320, 330, 340, 350, corresponding to execution paths 221-225, respectively, of FIG. 2 are illustrated. Records may be separated by a text-separator, for example, a carriage return, and may be organized in lines. In accordance with embodiments of the invention, the records may contain the entire data dumped in response to a resource-releasing command. For example, as illustrated, a first line of each record may contain a timestamp 302 at which a resource-releasing command is called, a second line may contain a thread ID 304 of the thread that called the resource-releasing command, a third line may contain a value 306 of the amount of resources freed by the command, and additional lines may contain values dumped from the BTS buffer or equivalent, for example, a list 308 of recently taken branches. As previously noted, the BTS buffer or equivalent may contain the source and destination addresses of branches taken during execution, and these may be dumped into output file 300 in reverse order from the order the related branches were executed. In addition, such a reverse ordering may be desired for aspects of the analysis stage, e.g., analysis step 124 of FIG. 1, and execution path selection, as discussed below with reference to FIGS. 4A-4D and FIG. 5. Although the invention is not limited in this respect, profiling output file 300 may display destination-source address pairs in separate lines so that each address line of record 310 may represent a range of sequentially executed instructions.

Referring again to FIG. 1, according to some demonstrative embodiments of the invention, the collected profiling data from profiling step 122 may be analyzed at analysis step 124, e.g., to identify resource-releasing operations and related computations that are well-suited for code division goals, e.g., that may be externalized to a protected processor on a server machine. Timestamps 302 may be used to monitor the distribution over time of the executions of the various resource-releasing commands. The time distribution data may help ensure that the unprotected part 134 of the modified program 130 may require the cooperation of the protected part 132 of the program throughout its execution. The amount of resources freed values 306 may be used to determine the profitability of performing calculations leading to a given instance of a resource-releasing command on the protected processor. The thread ID's 304 may be used to distinguish between profiling data dumped by different threads, and thus to determine the relations between contiguous resource-releasing instructions of the same thread. The lists 308 of recently taken branches may provide the relation between amount of resources freed and the execution paths which precede the related resource-releasing commands, as explained in detail below.

In accordance with embodiments of the invention, it may be desirable to produce a modified program that performs a minimal amount of calculations on the protected processor, so as to consume minimal resources of the protected processor and prevent any user-noticeable delay due to the burden of sending a large amount of computation requests from the user hardware to the protected processor. However, if too few computations are externalized to the protected part of the program, then adequate software protection might not be achieved. Thus, according to preferred embodiments of the invention, the protected part of the modified program may include only computations that influence resource-releasing commands that free, on average, a large amount of resources. It will be appreciated by those skilled in the art that the same instance of a resource-releasing instruction may release both large and small amounts of resources, e.g., memory, depending on the particular execution path and branches taken before execution of the resource-releasing command. It will be further appreciated the case where different execution paths release substantially different amounts of memory may be common in many computer programs. For example, referring to FIG. 2, execution paths 221 and 223 free, on average 150B of memory while execution paths 222, 224, and 225 free, on average 10B of memory, though all five illustrated paths execute the same free( ) system call.

According to some demonstrative embodiments of the invention, analysis step 124 may be performed by an automatic process, which may include a step of feeding the collected profiling data into a sophisticated data structure, for example, a hierarchical data structure such as a multiway tree. It will be appreciated by those with skill in the art that a multiway tree structure may contain a plurality of linked nodes such that each node may be linked to at most one parent node, directly above, and a number of child nodes directly below. As known in the art, a child of a child node may be referred to as a grandchild of the parent node; a node without a parent node may be referred to as a root node; and a node without any children may be referred to as a leaf node. It will be further appreciated that a multiway tree structure may have only one root node and that there may be only one path from the root node to a given leaf node. Therefore, a leaf node may represent the associated path from the root node to that leaf node.

Reference is made to FIG. 4A, which schematically illustrates a multiway tree structure 400 with profiling data inserted in accordance with some demonstrative embodiments of the invention. Although the invention is not limited in this respect, tree 400 may contain a plurality of nodes, e.g., a root node 410 and nodes 420, 430, 440, 445, 450, and 460 are illustrated. In accordance with embodiments of the invention, a direct child of the root node, e.g., node 420, may represent a basic code block that ends in a resource-releasing command, e.g., block 214 (B4) of FIG. 2. Subsequent child nodes, e.g., nodes 430 and 450, may represent other code blocks, e.g., blocks 213 (B3) and 212 (B2) of FIG. 2, respectively. The nodes of tree 400 may be arranged such that the children of a node correspond to code blocks possibly executed before the code block of that node, depending on the branches taken. For example, referring to FIG. 2, depending on whether a branch instruction at the end of block B2 is taken, either code block B3 or code block B2 may be executed before code block B4. This may be indicated by the hierarchal structure of the nodes in tree 400. Thus, a path from a node back to the root node may represent a specific execution path that ended with a resource-releasing command.

Although the invention is not limited in this respect, the nodes in tree 400 may contain data fields corresponding to, e.g., the records of profiling output file 300 of FIG. 3, as well as and additional data fields that may be useful for profiling analysis. For example, each non-root node may include a lines field 408 to represent the executed code blocks corresponding to the node; a total_size field 407 to represent the total amount of resources freed during execution of the paths passing through the node; and a count field 405 to represent the number of execution paths passing through a node. For example, as described above with reference to FIG. 2, more than one iteration of a computer program may take a given execution path at runtime. In addition, nodes may include a list field 409 to point to a linked list, as it is known in the art, containing, e.g., the children of the node or additional fields such as a timestamp field 402 to represent the timestamps of calls to the related resource-releasing commands or a freed-size field 406 to represent the amount of resources freed by those commands. Although the invention is not limited in this respect, field 409 of a non-leaf node may point to the children of that node, thus forming a hierarchal structure, while field 409 of a leaf node may point to a linked list storing, e.g., timestamp field 402 and associated freed-size field 406. In accordance with some demonstrative embodiments of the invention, the list 409 of a leaf node may be appended to represent subsequent iterations of an execution path associated with the leaf.

Reference is made to FIG. 4B, which schematically illustrates tree data structure 411 with partial profiling data inserted according to one demonstrative embodiment of the invention. Referring to the execution of computer program 110 in FIG. 2, the execution path of iteration I1, for example, from the beginning of the computer program to a call to a resource releasing command at line 115, may be represented in tree 411 by, e.g., a path from root node 410 to node 425, representing lines 110-115, to leaf node 441, representing lines 000-107. Although the invention is not limited in this respect, the first child node of root 410, e.g., node 425, may store the most recently executed code block in lines field 408, and subsequent nodes, e.g., node 441, may store previously executed code blocks in lines field 408. For example, such a structure may correspond to the order in which branch addresses are stored in, e.g., a BTS buffer or equivalent, during the profiling data collection phase. In addition, leaf node 441 may point to linked list, which may store the values of timestamp field 402 and freed-size field 406 corresponding to the resource-releasing command executed during iteration I1 of the computer program, e.g., 100 bytes of memory freed by a free( ) system call at timestamp 10. As tree 411 represents one iteration of a computer program, count field 405 may contain a value of 1. Insertion of profiling data relating to additional iterations of the computer program is described below with reference to FIG. 4C and 4D.

Reference is made to FIG. 4C, which schematically illustrates tree data structure 412 with splitting of a node to allow insertion of additional profiling data according to one demonstrative embodiment of the invention. Continuing the example of computer program 200 of FIG. 2, the execution path of iteration I2 may differ from the execution path of iteration I1. For example, iteration I2 may execute a range of lines skipped by iteration I1, and/or iteration I2 may skip, in whole or in part, a range of lines executed by iteration I1. According to some demonstrative embodiments of the invention, a node of tree 411, which may represent a consecutive address range executed during a first iteration of a computer program, may be split to allow insertion of profiling data corresponding to a second iteration of a computer program, which may execute a sub-range of the address range represented by the original node. For example, node 425 of FIG. 4B, representing lines 110-115 executed during iteration I1, may be split into node 421, representing the sub-range 114-115 executed by iteration I2, and node 431, representing the sub-range 110-113 skipped by iteration I2, as illustrated in FIG. 4C. Although the invention is not limited in this respect, splitting of a node may alter the lines field 408 and the child list pointed to from list field 409, while the count field 405 and total_size field 407 may remain unaltered. After splitting of a node, additional child nodes may be inserted into tree 412 to complete the representation of the execution path of iteration I2, as described below with reference to FIG. 4D.

Reference is made to FIG. 4D, which schematically illustrates a tree data structure 413 with further partial profiling data inserted after splitting of a node according to one demonstrative embodiment of the invention. Continuing the example of the execution of computer program 110 in FIG. 2 and of tree 412 of FIG. 4C, a node 455, representing lines 102-109 executed by iteration I2, may be added as a child of node 421 in parallel to node 431, appending the child list pointed to from list field 409. The count field of node 421 may be updated to represent that an additional execution path passes through the node, as illustrated at node 422. The process may be repeated until all profiling information is handled, resulting, for example, in tree 400 of FIG. 4A.

Reference is made again to FIG. 4A, which schematically illustrates data tree structure 400 with complete profiling information for the execution of computer program 110 in FIG. 2 inserted. For example, the execution path taken during iteration I1 may be represented on tree 400 by the path from root node 410 to leaf node 445, the execution path taken during iterations I2, I4, and I5 may be represented by the path from root node 410 to leaf node 460, and the execution path taken during iteration I3 may be represented by the path from root node 410 to node 440. It will be appreciated that nodes 440 and 460 may, for example, store the same values in lines field 408, yet represent different execution paths due to the arrangement of the paths in the data tree structure, as explained above, and may have different values stored in their data fields, e.g., total_size field 407.

Although the invention is not limited in this respect, an additional iteration following the same execution path as a previous iteration may update the values of, e.g., data in count field 405 and total_size field 407 of nodes representing code blocks the iteration executes. In addition, the linked list 409 may be updated to include values corresponding to the timestamp 402 and freed-size 406 of the call to a resource-releasing command executed by the additional iteration. It will be appreciated that other execution paths are possible, and may be accommodated by additional nodes of tree 400, some of which may split from the nodes illustrated. In accordance with embodiments of the invention, the same tree data structure may be used in order to present profiling information collected through several runs.

Reference is made to FIG. 5, which schematically illustrates a schematic flow chart 500 of an algorithm to select execution paths from a data tree structure for code division according to some demonstrative embodiments of the invention. Although the invention is not limited in this respect, analysis step 124 may include an automatic process, as stated above, to select execution paths suitable for externalization to the protected part 132 of the modified program. For example, profiling data collected during profiling step 122 may be organized in a hierarchal tree data structure, e.g., as described above with reference to FIGS. 4A-4D, and selection may follow the steps of algorithm 500, which may analyze the nodes of the tree.

According to some demonstrative embodiments of the invention, algorithm 500 may traverse the data tree structure and calculate for each, or at least some of the nodes a variable to represent the average amount of resources released during different executions of the execution path corresponding to the node. For example, the variable may be denoted rate and may be calculated as the ratio between the values of total_size field 407 and count field 405 of FIGS. 4A-4D. The value of rate may be stored within, or associated with, the corresponding node. In accordance with embodiments of the invention, rate may be used to identify execution paths which may release, on average, a large amount of resources. Algorithm 500 may select a small number of execution paths that release a large average amount of resources, i.e., that have a high rate value, for externalization to the protected part of the program, rather than a larger number of execution paths that release a smaller average amount of resources, i.e., that have a low rate value. It will be appreciated by those with skill in the art that this criterion may minimize the amount of calls to the protected processor, and thus minimize the protected processor's resource consumption, while providing software protection due to the dependence of the user hardware on the large amount of resources released through co-operation with the protected processor.

According to some demonstrative embodiments of the invention, algorithm 500 may select a set, e.g., S, of nodes from the tree corresponding to execution paths to be executed on the protected processor. As indicated at block 510, S may initially include all the direct children of the root node, which, as explained above with reference to FIG. 4A, may correspond to blocks ending in a resource-releasing instruction. As indicated at block 515, a variable, e.g., resources, may be calculated to represent the total amount of resources freed by the execution paths passing through the nodes in S. For example, resources may be determined by summing the values of the total_size fields of the nodes in S. As indicated at block 520, the value of resources for the set S may be compared to a predetermined threshold value, e.g., T, which may represent a minimal desired threshold of resources to be controlled by the protected processor in order to provide a desired degree of software protection, as explained above. Although the invention is not limited in this respect, threshold value T may be chosen to be several times, e.g., ten times, larger than the physical memory of an average computer on which the computer program is intended to be executed.

As indicated at block 550, algorithm 500 may stop and return the set S of selected nodes if the value of resources for S is less than or equal to the threshold value T. Otherwise, if the value of resources is greater than threshold value T, the selected node with lowest rate value may be removed from the set of selected nodes, as indicated at block 530, and replaced by several of its direct children, as indicated at block 540. Although the invention is not limited in this respect, the child nodes to replace the rejected node may be chosen to have a rate value higher than the rate value of the rejected node. For example, a minimum heap data structure may be used to determine which node in set S has the lowest rate and should be replaced. After updating the set S of selected nodes, as indicated at blocks 530 and 540, algorithm 500 may loop to block 515 and re-calculate the value of resources for the updated set S and re-perform the comparison with threshold value T as indicated at block 520.

It will be appreciated that successive iterations of algorithm 500 may decrease the vale of resources as nodes in S are replaced with a subset of their children. In accordance with embodiments of the invention, due to the hierarchal structure of the tree data structure, the total_size value of a node may equal the sum of the total_size value of that node's direct children. Thus, selecting a node and selecting all of that node's children may not alter the value of resources of S, while selecting only a subset of children may decrease the value of resources. Further, the initial value of resources for S may be maximal, as the set of all direct children of the root node may correspond to all possible execution paths ending in a resource releasing instruction.

Referring to FIG. 1, in accordance with some demonstrative embodiments of the invention, following the steps of profiling data collection, data analysis, and selection of execution paths, code-division process 120 may include code generation step 126 to create a modified program 130 having protected part 132 and unprotected part 134. Although the invention is not limited in this respect, all code blocks from the selected execution paths may be included within protected part 132 of the program. In accordance with embodiments of the invention, the code blocks executed by selected execution paths may end in a resource-releasing operation, as explained above with reference to FIG. 5, and may also include other logical operations and additional computations that influence the resource-releasing command, beginning at a branch point. In accordance with embodiments of the invention, unprotected part 134 of the program may initially include all of the code blocks of the original program, and the code generation process may exclude certain execution paths. For example, according to demonstrative embodiments of the invention, the code generation process may exclude from the unprotected part, e.g., a code block that is executed only by selected execution paths and not by un-selected execution paths. It will be appreciated that some code blocks, e.g., code blocks beginning at a branch point and containing logical operations and computations that may, or may not, lead to a resource-releasing command, may appear in both the protected and unprotected parts of the modified program.

For example, referring back to previous figures, selection algorithm 500 may select node 430 of tree 400 as corresponding to execution paths of program 110 that may release, on average, a large amount of resources, e.g., as indicated by the rate value of node 430. Further, node 430 may be the only selected node, and therefore only the corresponding execution path from node 430 to the root of tree 400 may be externalized to the protected part of the processor. For example, referring back to FIG. 2, the selected execution path of node 430 may correspond to part of iterations I1 and I3, and include basic code blocks B3 (213) and B4 (214), beginning at an entry point and ending at a resource releasing command. Thus, code blocks B3 and B4 may be included in protected part 132. Further, continuing the present example, there may not be any additional execution paths of program 110 that execute code block B3, which may therefore be excluded from unprotected part 134 of modified program 130. However, block B4 may be executed by additional execution paths, e.g., the paths of iterations I2, I4, and I5, and may therefore remain in unprotected part 134.

Although the invention is not limited in this respect, continuing the example of complied code 1 and source code 1, the following may represent a portion of the compiled code and corresponding source of unprotected part 134 generated at code-generation step 126:

### Compiled Code 2:

| | | |
|---|---|---|
| 101 | MOV | ECX,5 |
| 102 | MOV | EAX,ECX[3000] |
| 103 | PUSH | EAX |
| 104 | MOV | EAX,ECX[2000] |
| 105 | PUSH | EAX |
| 106 | MOV | EAX,ECX[1000] |
| 107 | PUSH | EAX |
| 108 | PUSH | 11325 |
| 109 | CALL | send_to_server |
| 110 | MOV | EAX,2 |
| 111 | MUL | EAX,[ECX]1000 |
| 112 | MUL | EAX,[ECX]2000 |
| 113 | MOV | EBX,[ECX]3000 |
| 114 | CMP | EAX,EBX |
| 115 | JEA | 119 |
| 116 | SUB | EAX,EBX |
| 117 | PUSH | EAX |
| 118 | CALL | free |
| 119 | LOOP | 102 |
| 120 | CALL | exit |

### Source Code 2:

for(i=5; i>0; i−−){

a=A[i];
b=B[i];
c=C[i];
send_to_server(a,b,c);
if(c < 2*a*b){

r = 2*a*b−c;
free(r);

}

}

Although the invention is not limited in this respect, continuing the example of complied code 1 and source code 1, the following may represent a portion of the compiled code and corresponding source of protected part 132 generated at code-generation step 126:

### Compiled Code 3:

| | | |
|---|---|---|
| 01 | POP | EAX |
| 02 | MUL | EAX,2 |
| 03 | POP | EBX |
| 04 | MUL | EAX,EBX |
| 05 | POP | EBX |
| 06 | CMP | EBX,EAX |
| 07 | JB | 13 |
| 08 | MUL | EBX,EBX |
| 09 | MUL | EAX,2 |
| 10 | SUB | EBX,EAX |
| 11 | PUSH | EBX |
| 12 | CALL | free_client |
| 13 | CALL | end_request |

### Source Code 3:

func11325(a,b,c){

if(c >= 2*a*b){

r = c\hat{ }2−4*a*b;
free_client(r);

}

}

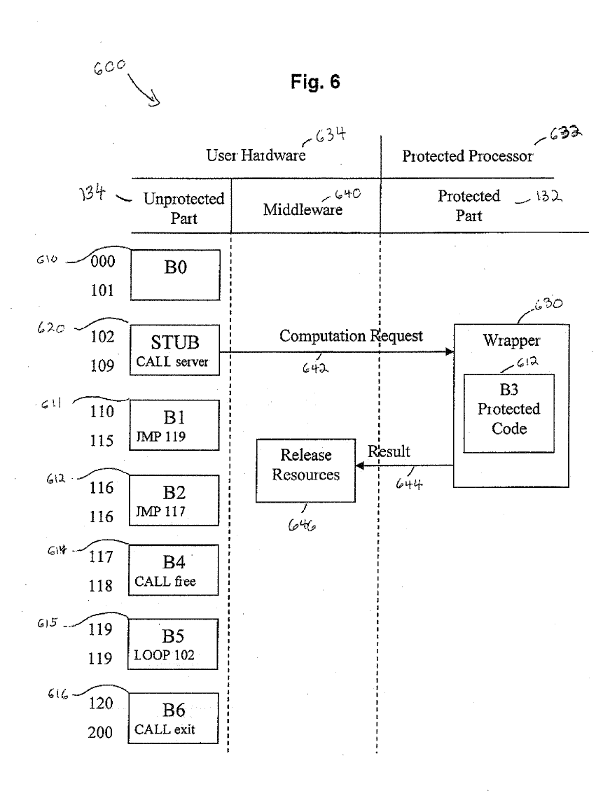

Reference is made to FIG. 6, which schematically illustrates a system 600 to execute a modified computer program 130 having a protected part 134 and an unprotected part 132 according to one demonstrative embodiment of the invention. Although the invention is not limited in this respect, modified program 130 may be generated by code generation step 126 from original program 110, following profiling step 122, e.g., with the aid of multiway tree 400 of FIGS. 4A-4D, and analysis step 124, e.g., selection of execution paths according to algorithm 500 of FIG. 5, as described above.

In accordance with some non-limiting demonstrative embodiments of the invention, unprotected part 134 of modified program 130 may include, for example, code blocks 610-612 (B0-B2) and 614-616 (B4-B6), which may correspond to code blocks 210-212 (B0-B2) and 214-216 (B4-B6) of FIG. 2, respectively. In addition, unprotected part 134 may include an additional code block 620, e.g., denoted stub, to gather parameters relating to the current execution path for communication to the protected part 132 of the program, e.g., in an updating message 642, as explained below. Protected part 132 may include a code block 613 (B3), which may correspond to code block 213 (B3) of FIG. 2. Code block 613 may be wrapped by a wrapper 630 of skeleton code, which may enable protected part 132 to receive the parameters from unprotected part 134 and to return results, e.g., instructions to release a previously-allocated resource, as explained below. It will be appreciated that code blocks 610-616 of modified program 130 may correspond to analogous code blocks 210-216 of original program 110, though line numbers may change, e.g., to accommodate insertion of stub 620, and addresses may be updated, e.g., to allow use of different memory addresses and registers of the protected processor. In accordance with some demonstrative embodiments of the invention, block 613 may be subsequently modified again to allow execution a different protected processor platform.

In accordance with some demonstrative embodiments of the invention, protected part 132 may be executed on a protected processor 632, and unprotected part 134 may be executed on a user hardware system 634. In addition, modified program 130 may include middleware 640 to be executed on user hardware 634 along with unprotected part 134. Although the invention is not limited in this respect, middleware 640 may perform tasks relating to, for example, communication between protected processor 632 and user hardware 634, e.g., via a TCP/IP or other network connection. For example, middleware 640 may locate a server including protected processor 632 and start a network session, including handling of authentication protocols. In addition, middleware 640 may execute subroutines relating to, for example, communicating parameters in an updating message 642 between unprotected part 134 and protected part 132, returning instructing messages 644, and resource-releasing 646.

Although the invention is not limited in this respect, protected processor 632 may be located on a server platform, which may be adapted to execute the protected part of more than one modified program. For example, during execution of modified program 130, stub 620 may, for example, push parameters relating to the current execution state, e.g., the currently executing path, onto the stack on user hardware 634. In accordance with embodiments of invention, parameters 632 may be associated with a code ID to identify which wrapper 630 should receive the execution state parameters. Stub 620 may call a subroutine, for example, named remote, to be executed by middleware 640. The remote subroutine may take the execution state parameters and associated code ID from the stack, pack the parameters and code ID in an updating message package 642, and send the updating message 642 to the protected processor 632, e.g., via a TCP/IP connection.

According to some demonstrative embodiments of the invention, protected processor 632 may receive an updating message 642 from user hardware 634, push the execution state parameters onto the stack, and call the appropriate wrapper 630 according to the associated code ID. Wrapper 630 may pop the execution state parameters from the stack on protected processor 632 and pass them to the corresponding protected code in protected part 132, e.g., code block 613, according to an expected format. Although the invention is not limited in this respect, protected code 612 may perform one or more operations utilizing the parameters to determine, e.g., whether the execution path leads to a resource-releasing command required by unprotected part 134, e.g., by emulating the corresponding portion of original program 110. For example, protected code 612 may determine a resource identifier of a no-longer-necessary resource on user hardware 634 that may be released. After the execution of protected code 612, wrapper 630 may call a subroutine 644 to return the resultant instructing message to the user hardware 634. In accordance with some demonstrative embodiments of the invention, the instructing message may be received by a process 646, e.g., executed by middleware 640, that may release resources according to the received instructions.

According to some demonstrative embodiments of the invention, the execution of unprotected part 134 on user hardware 634 may continue without being blocked after generation of a computation request 642 and may not require a response from the protected processor 632 in order to continue the execution flow. For example, the remote subroutine, called by stub 620, may put an updating message in a task queue and return upon submission of the message without waiting for a reply. Although the invention is not limited in this respect, cumulated messages from the task queue may be later processed by a working thread, e.g., by middleware 640, and thus contribute to the minimization of network traffic as several requests may be aggregated and transmitted within one physical packet. It will be appreciated that transmitting several updating messages in one packet may contribute to the minimization of network resource consumption of both the user hardware and the protected processor.

It will be appreciated by those with skill in the art that obfuscation of the relation between the sent parameters and received resource-releasing instructions may increase the overall security of a computer program. In accordance with some demonstrative embodiments of the invention, protected processor 632 may delay sending instructing message 644 to user hardware 634 by, for example, a random period of time, in order to complicate any attempt to expose the relation between the sent parameters and received resource-releasing instructions. Moreover, when considering a set of messages, protected processor 632 may send the resultant instructing messages 644 to user hardware 634 in an order other than that in which the respective updating messages were received.

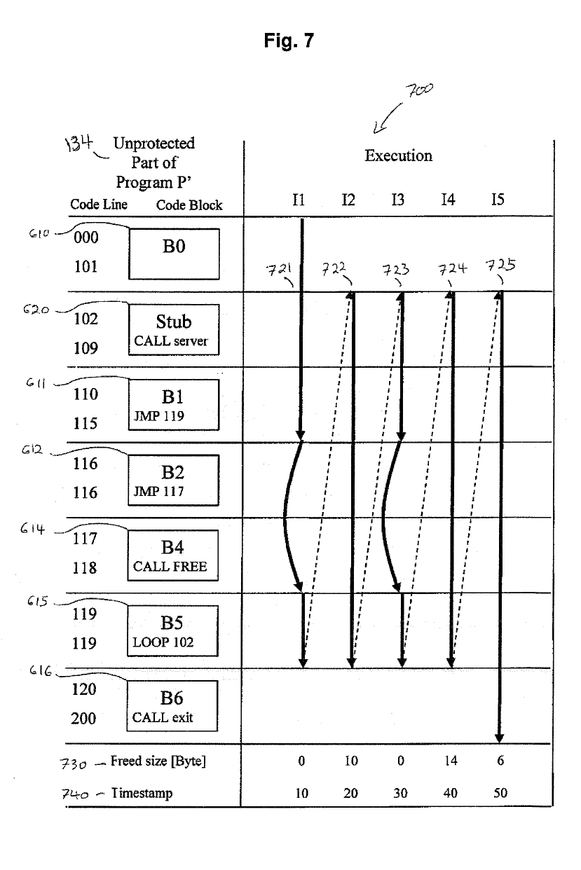

Reference is made to FIG. 7, which schematically illustrates part of an execution 700 of unprotected part 134, e.g., of modified computer program 130, according to some demonstrative embodiments of the invention. For example, execution 700 may include five iterations 721-725 (I1-I5) of a loop in modified program 130, e.g., corresponding to iterations 221-225 (I1-I5) of FIG. 2, respectively.

In accordance with some non-limiting demonstrative embodiments of the invention, the execution path of each of iterations 721-725 may include execution of the stub code 620 and sending execution state parameters to protected part 132, which may be able to perform one or more computation and/or logical operations using the parameters to determine whether there is a no-longer-necessary resource that may be released. For example, the path of iterations 722 (I2), 724 (I4), and 725 (I5), may take a branch that does not require the protected code block 613, and that includes block 614, which may include a resource releasing command, e.g., free( ). The path of iterations 721 (I1) and 723 (I3) may take a branch that skips the resource-releasing command in block 614, and that requires protected code block 613 in order to release resources. Thus, in accordance with demonstrative embodiments of the invention, as indicated at diagram line 730, the execution paths of iterations 722, 724, and 725 may be able to independently release a small amount of previously-allocated resources, while the execution paths of iterations 721 and 723 may be deficient of a mechanism for releasing resources. Although the invention is not limited in this respect, the execution state parameters gathered by stub 620 may not be directly linkable to the resource-releasing command without performing one or more operations, e.g., to determine the branches taken during execution.

Embodiments of the present invention may be implemented by software, by hardware, by firmware, or by any combination of software, hardware, and/or firmware as may be suitable for specific applications or in accordance with specific design requirements. Embodiments of the present invention may include units and sub-units, which may be separate of each other or combined together, in whole or in part, and may be implemented using specific, multi-purpose, or general processors, or devices as are known in the art. Some embodiments of the present invention may include buffers, registers, storage units, and/or memory units for temporary or long-term storage of data and/or in order to facilitate the operation of a specific embodiment.

The uses, applications and methods of employing the system of the invention previously described are numerous. It will be understood that the uses and applications of embodiments of the invention discussed herein are not exhaustive, but that others are possible and are within the scope and spirit of the invention, and are intended to be covered by the present application.

In embodiments of the invention, the determination whether to release the resource on the user machine may be determined based on a set of parameters received from the user machine, for example, as described above, and based on a policy. The policy may be as described in any of the below embodiments. The policy may dictate the conditions under which the resource may be released. The policy may be associated, for example, with a particular copy of the computer program being executed, or it may be associated with a user identification (for example, as identified by a user name and password). The policy may be dictated statically, or it may be changed dynamically by a supervisor.

According to one embodiment of the present invention, the Program Monitoring System may prevent an unauthorized use of a software application, for example, by setting the policy to permit use only by a list of authorized users. The protected processor may prompt the unprotected processor for a username and password each time the unprotected part of the program starts running. Then, only if the username and password pair is recognized as legal, the protected processor may execute the protected part of the software on behalf of the unprotected processor. If, while the protected processor runs the protected part of the program on behalf of that unprotected processor, another unprotected processor starts running the same program and provides the protected processor with the same pair of username and password, the protected processor will not run the protected parts of the program on behalf of this second unprotected processor. This way, for each legal pair of username and password, only one unprotected processor may execute the program concurrently.

According to one embodiment of the present invention, the Program Monitoring System may have a policy enabling a supervisor to control usage of a program by a user. Thus, for example, a program using the Program Monitoring System may be a computer game, a supervisor may be a parent, and the user may be a child or adolescent. The protected part of the program code may operate with the unprotected part only under circumstances permitted by the supervisor, who may have access via a password not known to the user.

In one example, the protected part may only operate when a password is entered by a supervisor in real-time. The supervisor may enter a maximum amount of time after the password is entered that the protected part may operate, or the operation may be until the program is terminated.

In another example, there may be provided an interface allowing the supervisor to dictate in advance policy conditions under which the protected part may operate. The interface may solicit various parameters limiting usage of the program, for example, by a total number of hours of operation in a given period (e.g., no more than 10 hours per week and no more than 2 hours per day), or by days and times (e.g., only on weekends and weekday evenings between 5 and 7 μm).

In yet another example, the supervisor may set a policy of releasing the resource based on a parameter of operation of the program. Thus, for example, if the program has various modes, each suitable to an age group, the supervisor may set a policy of restricting the operation of the protected part to operate with the unprotected part only for selected modes of operation.

According to one embodiment of the present invention, the Program Monitoring System may provide a central statistical unit with information regarding program usage. Each protected part of the program may gather statistical information and transmit the information to the central statistical unit. Information gathered may be operational information, for example, usage time, modules used, user information, etc., or it may be content-based information. This statistical information may then be gathered and manipulated by a statistical analysis module.

According to one embodiment of the present invention, the Program Monitoring System may be used to give trial or teaser usage of a program. Thus, the policy may be to permit usage temporarily, but not after a trial period and/or after a certain amount of usage time and/or usage intensity. A user may receive the unprotected part of the program, and connect to the protected part for temporary usage of the program, for example, using a temporary password. The protected part may permit operation with the unprotected part only during the validity of the user's profile.

Thus, for example, trial version may be limited in time, such that the protected part will no longer operate with the unprotected part after the time limit (e.g., 30 days) has passed. In another example, a program may have a number of modes, and the teaser version may limit a user to only a small or rudimentary number of such modes. In another example, a game program may have a number of skill levels, and a teaser version may be associated with a policy permitting the protected part to operate with the unprotected part only for a first level, and not for higher levels. In yet another example, a teaser version of a game may have a policy of permitting accumulation of only a limited number of credits, thereby limiting the user's advancement in the game unless a full version is purchased or licensed.

In a teaser version, the protected processor may determine when to terminate operation with the unprotected part based on a variable threshold, rather than a fixed time period. For example, the protected processor may monitor a user's intensity of playing the game by analyzing several parameters, such as average play time per day. The protected processor may then stop operating with the unprotected part of the program when a policy threshold of user play intensity has been reached or is being approached, thereby increasing the likelihood that the user will purchase a full version of the game when the trail period ends.

According to one embodiment of the present invention, the Program Monitoring System may be used to share user information among a set of programs. Thus, a user may have a single username-password pair that allows him to execute multiple programs. Each program that the user may execute can be considered as bound to the user's account.

In one embodiment, a user may have several programs bound to his account, but only be able to run one program at a time. In another embodiment, the policy may be to a lot to a user a quota of usage time, wherein the quota may be used for one or a plurality of programs that are bound to his account. In yet another embodiment, a user may pay a price for binding a program to his account and use it as much as he wishes, and receive credit for purchasing a second program when unbinding the first program from his account. For example, a user may accumulate points according to the play time and number of games that are bounded to his account. These points can entitle the user to a discount or credit upon binding another game to his account, say purchasing another game or adding more time quota to his account, say purchasing time.

According to one embodiment of the present invention, which may also include persistent user account features described above, the Program Monitoring System may allow a user to unbind a program from his account and permit another user bind that same program to that user's account, for example, by passing the license of the program to that other user. Thus, when a user request from the protected processor a transfer of a program license to another user, for example, upon second-hand sale of a game program, the protected processor may require that a transfer fee be paid in order to complete the license transfer operation. In some embodiments of the invention, there may be a virtual marketplace where users can trade in program licenses.

It will be recognized that the above are only some uses of a Program Monitoring System, and others consistent with the above are possible, and are included within the present invention.

While certain features of the invention have been particularly illustrated and described herein, many modifications, substitutions, changes, and equivalents may occur to those of ordinary skill in the art. It is, therefore, to be understood that the appended claims are intended to cover all such modifications and changes in form and details as fall within the true spirit of the invention.

What is claimed is:

1. A method comprising:
receiving at least one set of parameters relating to an execution of a computer program being executed on a user machine, said computer program being deficient of a mechanism to release a resource;
determining based on said set of parameters and a policy whether said resource on said user machine is to be released; and
if said resource is to be released, sending a result of performing said set of operations to said user machine to instruct the release of said resource on said user machine.

2. The method of claim 1, wherein said set of parameters includes a user identification.

3. The method of claim 2, wherein determining whether said resource is to be released comprises determining whether said user identification is authorized to execute said computer program.

4. The method of claim 2, wherein determining whether said resource is to be released comprises determining whether said user identification is associated with a computer program being executed concurrently on a different user machine.

5. The method of claim 1, wherein determining whether said resource is to be released comprises determining whether releasing said resource is authorized by a supervisor.

6. The method of claim 5, wherein determining whether releasing said resource is authorized by a supervisor comprises:
after receiving said at least one set of parameters, prompting said supervisor for authorization to release said resource; and
if said supervisor authorizes releasing said resource, then instructing the release of said resource on said user machine.

7. The method of claim 1, wherein said policy comprises a time parameter, wherein determining whether said resource is to be released comprises determining whether said time parameter has been exceeded.

8. The method of claim 7, wherein said time parameter is a total execution time maximum, and wherein determining whether said resource is to be released comprises determining whether a total time of execution of said computer program by said user machine exceeds said total execution time maximum.

9. The method of claim 7, wherein said time parameter is a lapsed time parameter, and wherein determining whether said resource is to be released comprises determining whether a total time lapsed exceeds said lapsed time parameter.

10. The method of claim 9, wherein said total time lapsed is measured from an initial time marker selected from the group consisting of: a first execution of said computer program on said user machine, and a first execution of said computer program by an identified user.

11. The method of claim 7, wherein said time parameter is a schedule of authorized times of operation, and wherein determining whether said resource is to be released comprises determining based on said schedule of authorized times of operation whether said resource to be released.

12. The method of claim 1, wherein said computer program is associated with a plurality of modes of operation, and wherein said set of parameters includes a current mode of operation of said computer program being executed on said user machine, wherein said policy includes an authorization for at least one of said modes, and wherein determining whether said resource is to be released comprises determining whether said current mode of operation is authorized based on said policy.

13. The method of claim 1, wherein said set of parameters includes a user identification and wherein said policy comprises an authorization policy for said user identification for a plurality of computer programs.
